(19) United States
(12) Patent Application Publication
(10) Pub. No.: US 2024/0150623 A1
(43) Pub. Date: May 9, 2024

(54) ADHESIVE TAPE

(71) Applicant: Certoplast Technische Klebebänder GmbH, Wuppertal (DE)

(72) Inventor: Rene RAMBUSCH, Wuppertal (DE)

(21) Appl. No.: 18/269,039

(22) PCT Filed: Sep. 14, 2021
(86) PCT No.: PCT/EP2021/075236

§ 371 Date: Jun. 26, 2023

(30) Foreign Application Priority Data
Jan. 28, 2021 (DE) 20 2021 100 428.2

(51) Int. Cl. C09J 7/38; C09J 7/21; C09J 7/22; C09J 7/29

(52) U.S. Cl. CPC C09J 7/385; C09J 7/21; C09J 7/22; C09J 7/29; C09J 2203/302; C09J 2301/124; C09J 2301/204; C09J 2433/00

(57) ABSTRACT

An adhesive tape, in particular a wrapping tape for sheathing cables in automobiles, comprising a substrate, and a polymer adhesive coating on at least one side is characterized in that the adhesive coating is produced using polymers that are derived from CO2-based monomers.

The invention relates to an adhesive tape, in particular an angle tape for spiral-wrapping cables in an automobile, comprising a substrate and a polymeric adhesive coating on at least one face of the substrate.

Such adhesive tapes and in particular wrapping tapes are used for longitudinal-sheath or helical wrapping of cables in automobiles, in order to protect the cables, for example from environmental influences, scraping stresses, etc. to protect and combine them together. Such adhesive tapes and in particular winding tapes are known in various embodiments in the prior art, to which reference is made only by way of example to DE 20 2018 103 986 [US 2021/0261826] of applicant. In this case, a textile substrate or fabric substrate is used. In addition, however, a multilayer construction of the substrate is also possible, as is for example the subject matter of DE 20 2018 101 383 [US 2021/0002519].

Adhesive tapes and, in particular, winding tapes for wrapping or wrapping cables in automobiles must meet a variety of requirements. First of all they must have a particular media resistance with respect to, for example, oil and gasoline. High temperature resistance is also required. In fact, such adhesive tapes should typically be used in the range between −50° C. and +150° C. and more. In addition, low sound emissions are sought, for example in such a way that rattling noises of a wrapped cable harness or of cable bundles are prevented as far as possible.

In addition to these above-described requirements, a high abrasion resistance is often also required. As a result, a scraping away on the vehicle body must be prevented, so that the cables wrapped in this way are reliably protected against any damage. The abrasion resistance can be determined in accordance with standard LV 312(2009) on the basis of abrasion classes and the adhesive tape can be classified and grouped accordingly in this way.

In addition to the requirements described above, there is often a further requirement to be able to manually tear the adhesive tape or tape in question. This is because the winding tapes in question are typically wound or wrapped in a spiral or helical manner by an assembly worker around the cable bundle to be provided accordingly. The adhesive tapes or tapes must be precut to length before application. This is most simply done by simple tearing.

More recently, requirements for improved recycling capability and, in particular, the resource-saving production of such adhesive tapes are increasingly arising. Since nowadays cable sets in automobiles can have total lengths of several kilometers of copper lines, the consumption of corresponding winding tapes for producing the cable harnesses has also increased considerably in comparison to the past. As a result, a resource-saving production results in increased and particular importance.

In this connection, approaches are already followed in the prior art according to WO 2015/071 447 [US 2016/0304751] to provide an adhesive tape with a substrate material including at least one layer with at least 75 wt. % polylactic acid. Polylactic acids or polylactides (PLA) are polyesters based on lactic acid, that is to say thermoplastic plastics, consisting of lactic acid molecules. Since such lactides are of natural origin, they can be produced by fermentation of molasses or by fermentation of glucose with the aid of bacteria.

A particular advantage of such polymers is that the polymer is completely compostable and biodegradable as polyhydroxy carboxylic acid. Only water and carbon dioxide are observed as degradation products.

Such bio-based substrate materials have proven successful in principle, but are problematic overall with regard to the additional CO² emitted during composting. The same applies, of course, to other substrate materials produced petrochemically and in the manufacture of which, inter alia, CO² is also produced as combustion gas. At this point, the further requirement in space is to reduce as much as possible the CO² content in the air. For this purpose, there are already various approaches to producing polymers from the air by CO² recovery as described in principle and by way of example in WO 2018/231620 [U.S. Pat. No. 10,544,080]. Comparable methods describe WO 2017/106176 [U.S. Pat. No. 10,160,711]. Such methods have hitherto not been used in and in conjunction with the manufacture of adhesive tapes.

The object of the invention is to develop such an adhesive tape in such a way that the manufacture takes place in a particularly resource-saving manner.

In order to attain this object, an adhesive tape of the generic type in the context of the invention is characterized in that the adhesive coating is produced using polymers derived from CO²-based monomers.

According to the invention, the adhesive coating is consequently produced at least partially using CO². The CO² is advantageously recovered from the air as combustion gases, in particular on the basis of petrochemical combustion. With the aid of the CO² thus obtained, monomers are produced from which polymers are again derived for producing the polymeric adhesive coating. More specifically and advantageously, the acrylate-based adhesive coating is prepared. Accordingly, in this case, the adhesive coating is produced by polymerization of CO²-based acrylic acid esters. This means that the acrylic acid esters produced based on CO² are polymerized in order to obtain the acrylate for the acrylate coating as an adhesive coating. It is possible to work with pure acrylates, that is to say those based exclusively on the acrylic monomers. However, it is also possible to work with copolymers as is the case for thermosetting acrylate resins that are often used as an adhesive coating and that furthermore have functional groups from comonomers (for example hydroxy, carboxy groups).

Thus, the adhesive coating is prepared using a polymer and, in particular, acrylates. The polymer or acrylate is in turn produced from CO²-based monomers. The acrylate-based adhesive coating can, of course, be provided with further additives such as tackifier resins, tackifiers, etc. as required. What is decisive is the fact that the polymer production or acrylate production takes place wholly or partially using CO², that is in turn advantageously separated from combustion gases by petrochemical combustion. As a result, the polymer production for the adhesive coating functions as a similar CO² sink, so that not only is particularly advantageous work carried out in a resource-saving manner, but even the CO² content is reduced by the manufacture of the adhesive coating in question and the process is not only climate-neutral but even climate-improving.

The polymer adhesive coating can be produced by making unsaturated carboxylic acids such as, for example, acrylates from olefins and CO². A suitable process is, for example, the preparation of acrylates by reacting carbon dioxide with olefins in the presence of a nickel-bisphosphine catalyst and a base as explained in detail, for example, in the introductory part of the description of DE 10 2013 210 840 [US 2016/0130208]. In the context of the above-mentioned application, the unsaturated carboxylic acids are prepared from olefins and CO² with the addition of salts from the group of alkali metal halides as catalysts. The halides used at this point are easily accessible and easy to handle and can easily be separated out and reused. In addition, the synthesis of unsaturated carboxylic acids or salts thereof can take place directly from the starting materials, an olefin and CO².

In any case, well known and established methods are available in order to be able to produce an acrylate-based adhesive from essentially CO² that in turn is advantageously used as an adhesive coating in the manufacture of adhesive tapes. Since the CO² required is typically separated from combustion gases, there is the possibility in this way to be able to contribute to the reduction of climate-harmful gases and in particular of carbon dioxide by the manufacture of the adhesive tapes according to the invention. This advantage is already observed and implemented when the adhesive coating is produced predominantly using the polymers derived from CO²-based monomers. That is to say, as a rule, the CO²-based monomers represent the main constituent of monomers. In principle, however, monomer mixtures from different sources can also be used in making the polymers for the adhesive coating Finding. It is thus conceivable to additionally resort to petrochemically produced monomers in addition to the CO²-based monomers as the main constituent. Alternatively or additionally, monomers based on renewable raw materials can also be used for the manufacture of the polymers for the adhesive coating.

In the case of the monomer mixtures, the CO²-based monomers regularly represent the main constituent (more than 50% by wt. %). It is even possible for the adhesive coating to be applied exclusively using the CO²-based monomers (i.e. to 100 wt. %). In addition, monomer mixtures are also conceivable according to the invention that additionally or alternatively are based on petrochemically produced monomers or monomers based on renewable raw materials and in particular bio-based monomers. The essential advantages are to be seen herein.

As a rule, the adhesive coating is applied to the substrate on one or both faces. The adhesive coating can in turn be formed over the entire surface or in the form of a stripe. In this case, a strip of the adhesive coating is recommended in particular in order to reduce the consumption of adhesive.

The adhesive advantageously used is generally a UV-crosslinkable acrylate adhesive. As a result, the adhesive coating is generally crosslinked after its application, in particular radiation-crosslinked, typically subjected to crosslinking with the aid of UV-radiation sources.

Suitable substrates are any substrate materials suitable at this point, such as, for example, films, paper or also textiles. In addition, combinations are also conceivable in such a way that the substrate is a laminate.

A particularly advantageous variant within the scope of the invention is characterized in that the substrate is produced by using bio-based polymers. The at least partial feedback to bio-based polymers means and expresses that the mass fraction of the bio-based polymers in the substrate is at least 5% by mass. That is, at least 5% by mass of the substrate is made of bio-based polymer material, i.e. based on renewable natural resources. In the case of the bio-based polymers in question or “bioplastics” are typically those based on raw materials that, in particular, have starch and cellulose as biopolymers of sugars.

In fact, these bio-based polymers can be mixed with plastic polymers, inter alia, and used to produce the substrate. Of course, the substrate can also be completely produced from the bio-based polymers. The latter plastic polymers are those produced on the basis of petrochemical raw materials and their by-products. In contrast, natural resources are used exclusively for the bio-based polymers.

Plant materials and in particular starch-containing plants such as maize or sugar beets and wood have proved to be favorable as the starting point for the renewable raw materials and thus the bio-based polymers for producing the substrate from which cellulose can be obtained. Further possibilities for making such bio-based polymers are plants such as sugar cane, sugar beet, corn, grain, barley, potatoes, sugar palm, cassava, algae, ahorn, agave, sweet potatoes, etc. to name just a few. In principle, bio-based polymers are also conceivable with regard to lactic acid, so-called polylactides, as have already been described above.

Within the scope of a particularly advantageous and resource-saving variant, the substrate is generally produced as a textile made of bio-based polymer fibers and/or polymer filaments. That is to say, the textile substrate is produced completely or almost completely from the mentioned bio-based polymers with an associated mass fraction of up to 100% by mass. In principle, mixed forms of bio-based polymers and plastic polymers based on petrochemical are also conceivable. Likewise, multilayer substrates in which, for example, a textile substrate is used on bio-based polymers and on the basis of plastic polymers in the sense of a laminate or also as a mixed form.

That is, the substrate can be designed as a single-layer as well as a multilayer laminate. In this way, at least abrasion class B can be achieved according to LV 312(2009) or else class C or even more in each case measured in such a way that the adhesive tape with a 5 mm tip taking into account a weight load of 10 N, corresponds to the strokes associated with the associated class until wearing-through as is described by way of example in DE 20 2012 103 975 [U.S. Pat. No. 10,351,734]. In fact, the abrasion class B corresponds to 100 to 499 strokes and is preferably even achieved by the abrasion class C with 500 to 999 strokes.

The bio-based polymer can be bio-based PE (polyethylene), PP (polypropylene), PS (polystyrene), PVC (polyvinyl chloride), PET (polyethylene terephthalate), PVA (polar vinyl acetate), PU (polyurethane) or also PLA (polylactams) and combinations thereof. In addition, it has proven useful if the thickness of the substrate is less than 0.8 mm in order not to provide the cables with a wrapping that is too thick. The adhesive coating is generally applied to the substrate with an application weight of 20 g/m² to 200 g/m². The invention also relates to a wiring harness that is provided with a plurality of electrical cables extending longitudinally and that in turn is wound in a spiral with an adhesive tape of the above-described structure or is longitudinally sheathed with the adhesive tape of the previously described structure.

As a result, a particularly resource-saving adhesive tape is described and provided. It is first distinguished by an adhesive coating that uses CO² for its production that acts as a similar CO² sink and is thus produced in a particularly climate friendly and, in a particular, even climate-improving manner. For this purpose, it is further provided that bio-based polymers are particularly advantageously used for the substrate for the manufacture thereof. The bio-based polymers are typically those whose chemical structure is identical to those of conventional plastics so that processing in the form of polymer fibers and/or filaments is particularly simple and possible with conventional systems.

Consequently, it is possible in this way to produce textile substrates in the form of nonwovens, woven fabrics or also as velour in a particularly simple and cost-effective manner that decompose without residue and use natural resources. That is to say, due to the identical chemical structure of the bio-based polymers for the manufacture of the textile substrate, for further processing to end products and consequently also the adhesive tapes described in this context, the same machines and methods can be used as are used in the case of previously realized plastic polymers or petrochemically made products.

Thus, it is possible to produce, for example, PET (polyethylene terephthalate) as a mass plastic by the polycondensation of monoethylene glycol (or ethylene glycol) and thermophthalic acid. Hitherto, only partially bio-based PET is offered at this point, in which the monoethylene glycol (about 30 wt. %) is like molasses produced from sugar. By contrast, terephthalic acid was predominantly petrochemically produced. According to the invention, however, the terepththalic acid can also be produced economically and bio-based, so that a mass-suitable product is thereby available. The essential advantages are to be seen herein.

1. An adhesive tape, in particular an angle tape for sheathing cables in automobiles, comprising:
a substrate and
a polymeric adhesive coating on at least one face of the tape, the adhesive coating being made using polymers derived from CO²-based monomers.

2. The adhesive tape according to claim 1, wherein the CO² is separated from combustion gases based on, in particular, petrochemical combustion.

3. The adhesive tape according to claim 1, wherein the adhesive coating is produced from acrylate.

4. The adhesive tape according to claim 3, wherein the adhesive coating is composed of acrylic acid esters produced by polymerization of CO²-based acrylate-ester acids.

5. The adhesive tape according to claim 1, wherein the adhesive coating is applied to the substrate on both faces of the tape.

6. The adhesive tape according to claim 1, wherein the adhesive coating is formed over all of the one face or in the form of a strip.

7. The adhesive tape according to claim 1, wherein the adhesive coating is crosslinked after its application.

8. The adhesive tape according to claim 1, wherein the substrate is a film, paper or textile or a combination thereof.

9. The adhesive tape according to claim 1, wherein the substrate is produced by using bio-based polymers.

10. The adhesive tape according to claim 9, wherein the substrate is produced as a textile substrate made of bio-based polymer fibers and/or polymer filaments.

11. The adhesive tape according to claim 9, wherein the bio-based polymer is PE, PP, PS, PVC, PET, PVA, PU, PLA or a combination thereof.

12. The adhesive tape according to claim 1, wherein the substrate is formed in one or more layers.

13. The adhesive tape according to claim 1, wherein the thickness of the substrate is less than 0.8 mm.

14. The adhesive tape according to claim 1, wherein the adhesive coating has an application weight of 20 g/m² to 200 g/m².

15. A wiring harness, comprising a plurality of electrical cables that extend longitudinally and that are wound with an adhesive tape helically or are longitudinally sheathed with the adhesive tape according to claim 1.
